(19) United States
(12) Patent Application Publication
(10) Pub. No.: US 2015/0266189 A1
(43) Pub. Date: Sep. 24, 2015

(54) LIQUID-DISPENSING RAZOR

(71) Applicant: UMM AL-QURA UNIVERSITY, MAKKAH (SA)

(72) Inventor: SALEH ALSALAMEH, QASSIM (SA)

(73) Assignee: UMM AL-QURA UNIVERSITY, MAKKAH (SA)

(21) Appl. No.: 14/218,908

(22) Filed: Mar. 18, 2014

(51) Int. Cl. B26B 21/44; B26B 21/14; B26B 21/52; B26B 21/04

(52) U.S. Cl. CPC B26B 21/446; B26B 21/04; B26B 21/14; B26B 21/52

(57) ABSTRACT

The liquid-dispensing razor provides liquid flow from a plurality of small pores or orifices immediately below the blade(s), to moisturize the beard at all times during shaving. The liquid is provided from a remote source (water tap or portable container) through a hose or line connected to the razor handle. The liquid flows through a passage through the handle, to the razor head, where it flows from the pores adjacent to the blade(s). The razor may include a control valve in the handle, or a remotely located foot-actuated valve may be provided in the water hose or line. A hand- or foot-actuated pump may be provided to create pneumatic pressure in the portable liquid container to force the liquid up through the line. The razor head may be removed to fill the hollow handle with shaving lather or gel, the liquid flow entraining the lather or gel for shaving.

### BACKGROUND OF THE INVENTION

1. Field of the Invention

The present invention relates to personal hygiene and grooming aids, and particularly to a liquid-dispensing razor capable of dispensing water or other liquid from various sources for moistening the beard for shaving.

2. Description of the Related Art

Innumerable innovations in personal grooming and shaving have been developed over the years, from the straight razor and shaving soap to the modern multiple blade safety razor and pressurized container of shaving cream, or the electric razor for those who prefer such devices. Where non-electric razors are used, it is virtually a universal requirement that some means of moisturizing the beard be provided in order to soften the bristles to facilitate their cutting and to retain the edge on the blade(s) for a somewhat longer time. This is normally accomplished by initially moistening the beard with water and applying shaving cream, and then using the razor to shave. However, the time delay between moistening the beard and applying shaving cream and actually shaving a given area, may be several minutes by the time the shaving has been completed. In warmer and dryer climates this can result in some areas of the beard drying before they can be shaved, necessitating a reapplication of water and/or shaving cream.

Thus, a liquid-dispensing razor solving the aforementioned problems is desired.

### SUMMARY OF THE INVENTION

The liquid-dispensing razor includes an elongate handle portion with a razor or shaving head at one end thereof. In some embodiments a source of water is connected to the distal end of the handle, i.e., opposite the razor head, and the water flows up through a passage in the handle to the razor head. A large number of small pores are provided across the head immediately below or in front of the cutting edge(s) of the blade(s). A control valve may be provided in the handle adjacent the head to control the water flow.

The water supply may be provided by a flexible hose or water line connected to a conventional water tap. The control valve may alternatively comprise a foot-actuated control valve installed in-line in the water hose or line. Alternatively, a portable water source may be provided in the form of a small canister or other container. A foot-actuated pneumatic pump may be provided to pressurize the container in order to force water up the water hose or line to the razor, or the foot-actuated pump may comprise a water pump to move the water up through the hose or line. Alternatively, a hand-actuated pump and container may be provided. The pump may be electrically operated rather than being operated by manual or pedal force, if so desired.

The razor head may be removed from the handle to access the cavity or passage through the handle. This allows the cavity to be filled with some additional shaving treatment, e.g., lather or gel from a tube, etc. The water flow through the cavity of the handle entrains the lather or gel therethrough, thereby serving to lather the beard simultaneously as the razor is being used for shaving. Alternatively, the end of the handle may have a removable cap for filling the handle cavity.

The razor may include a small mechanical or pneumatic pump for pressurizing the attached container handle to dispense the water or other material within the handle cavity. Another related embodiment has a handle with two separate compartments or cavities, one for water and another for a shaving gel or other fluid. The compartments or cavities are pressurized independently of one another by separate pushbutton actuators. While the various embodiments noted above are directed to safety razors, another embodiment comprises a straight razor having a handle with a fluid dispensing cavity therein.

These and other features of the present invention will become readily apparent upon further review of the following specification and drawings.

### BRIEF DESCRIPTION OF THE DRAWINGS

FIG. 1 is an environmental, perspective view of a liquid-dispensing razor according to the present invention, showing the back of the razor and details thereof.

FIG. 2 is an environmental, perspective view of the liquid-dispensing razor according to the present invention, showing the front of the razor and details thereof.

FIG. 3 is an environmental perspective view of the liquid-dispensing razor according to the present invention, showing the internal water passage within the handle in broken lines and the control valve.

FIG. 4 is an environmental perspective view of a remote foot-actuated water control valve for a liquid-dispensing razor according to the present invention.

FIG. 5 is an environmental perspective view of a portable water source and foot-actuated water control valve for a liquid-dispensing razor according to the present invention.

FIG. 6 is a perspective view of a liquid-dispensing razor according to the present invention, showing shaving lather or the like being loaded into the internal reservoir of the razor.

FIG. 7 is an exploded perspective view of another embodiment of the liquid-dispensing razor according to the present invention, showing the dispensing handle removed from the razor head.

FIG. 8 is an exploded perspective view of another embodiment of the liquid-dispensing razor according to the present invention, illustrating a safety razor handle having dual fluid containing compartments therein and corresponding pressurizing controls on the razor.

FIG. 9 is a perspective view of a hand-operated pressure container for use with the liquid-dispensing razor according to the present invention.

FIG. 10 is a perspective view of another embodiment of the liquid-dispensing razor according to the present invention, wherein the razor is a straight razor having a fluid dispensing handle.

FIG. 11 is a perspective view of another embodiment of the liquid-dispensing razor according to the present invention, the handle being broken away and in partial section, wherein the razor is a safety razor having a mechanical liquid-dispensing apparatus in the handle.

FIG. 12 is a perspective view of another embodiment of the liquid-dispensing razor according to the present invention, a portion of the handle being removed to show details thereof, wherein the razor is a safety razor having another mechanical liquid=dispensing apparatus in the handle.

FIG. 13 is a perspective view of another embodiment of the liquid-dispensing razor according to the present invention, a portion of the handle being removed to show details thereof, wherein the razor is a safety razor having another mechanical liquid-dispensing apparatus in the handle.

FIG. 14 is a perspective view of another embodiment of the liquid-dispensing razor according to the present invention, the handle being broken away and in partial section, wherein the razor is a safety razor having another mechanical liquid-dispensing apparatus in the handle.

FIG. 15 is a broken away, detailed perspective view of an alternative embodiment of a safety razor head of a liquid-dispensing razor according to the present invention, illustrating various details thereof.

FIG. 16 is a broken away, detailed perspective view of another alternative embodiment of a safety razor head of a liquid-dispensing razor according to the present invention, illustrating various details thereof.

FIG. 17 is a perspective view in partial section of another embodiment of a liquid-dispensing razor according to the present invention, comprising a straight razor having a handle and a mechanical liquid-dispensing apparatus the handle.

FIG. 18 is a perspective view of another embodiment of a liquid-dispensing razor according to the present invention, a portion of the handle being removed to show details thereof.

FIG. 19 is a perspective view of another embodiment of a liquid-dispensing razor according to the present invention, a portion of the handle being removed to show details thereof.

FIG. 20 is a perspective view, partially in section, of another embodiment of a liquid-dispensing razor according to the present invention.

Similar reference characters denote corresponding features consistently throughout the attached drawings.

### DETAILED DESCRIPTION OF THE PREFERRED EMBODIMENTS

The liquid-dispensing razor provides for the dispensing and control of water flow from the razor to keep the beard moistened during shaving. Various embodiments provide water and the means to deliver the water to the razor from various sources.

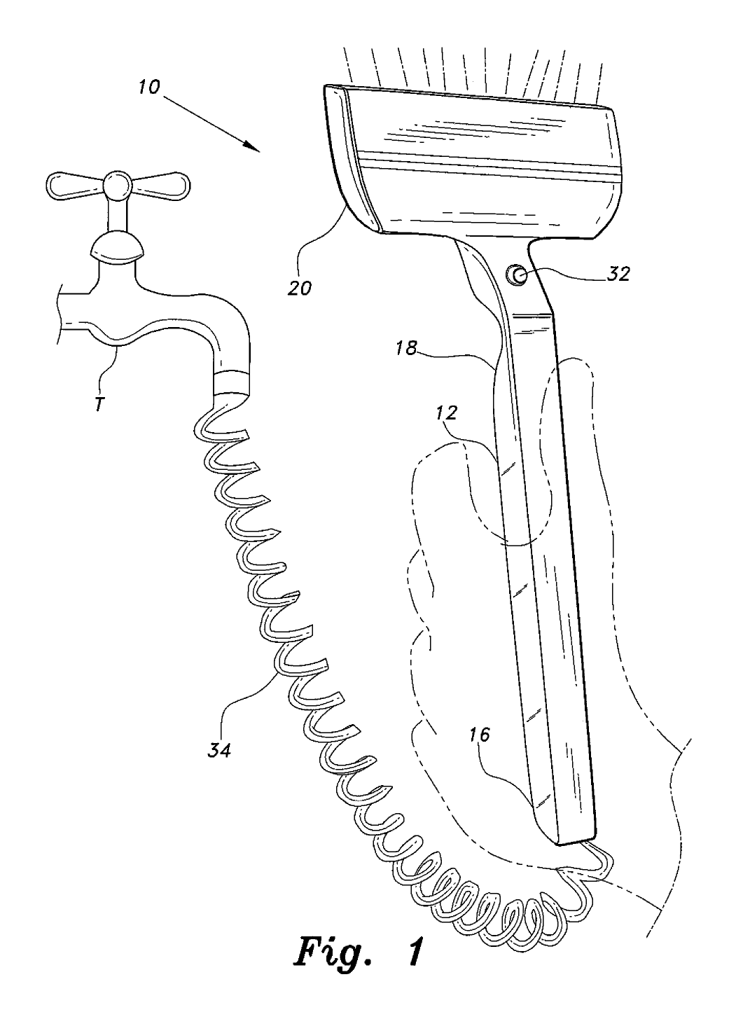

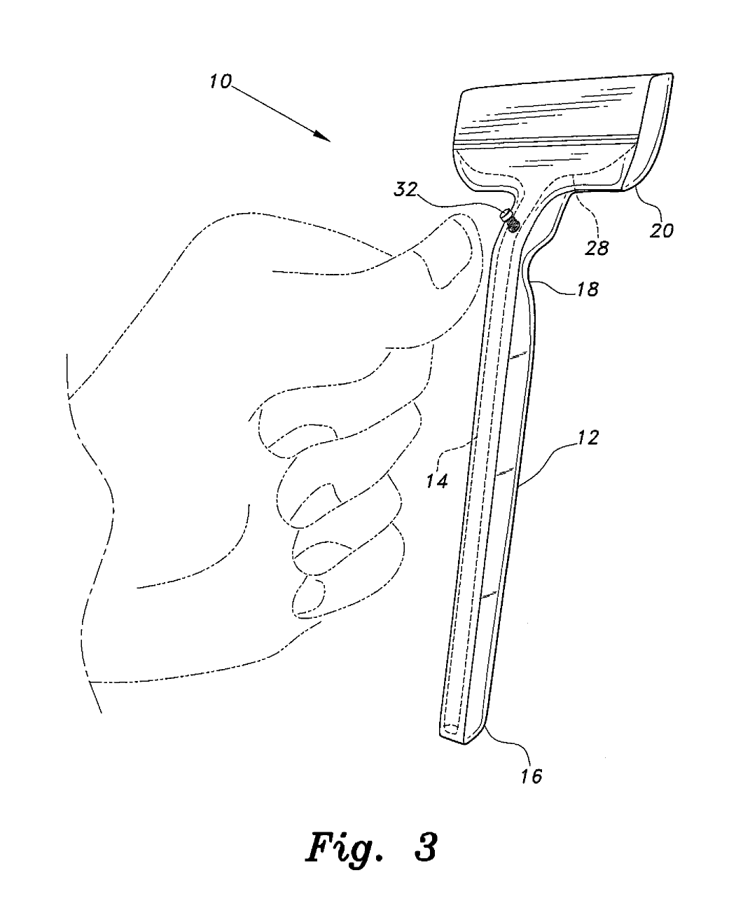

FIGS. 1 through 3 provide views of the liquid-dispensing razor 10, illustrating various features thereof. The razor 10 includes a hollow, elongate handle 12 having a water passage 14 extending therethrough (shown in FIG. 3), the handle 12 having an inflow end 16 and an opposite outflow end 18 to which the razor head 20 is attached.

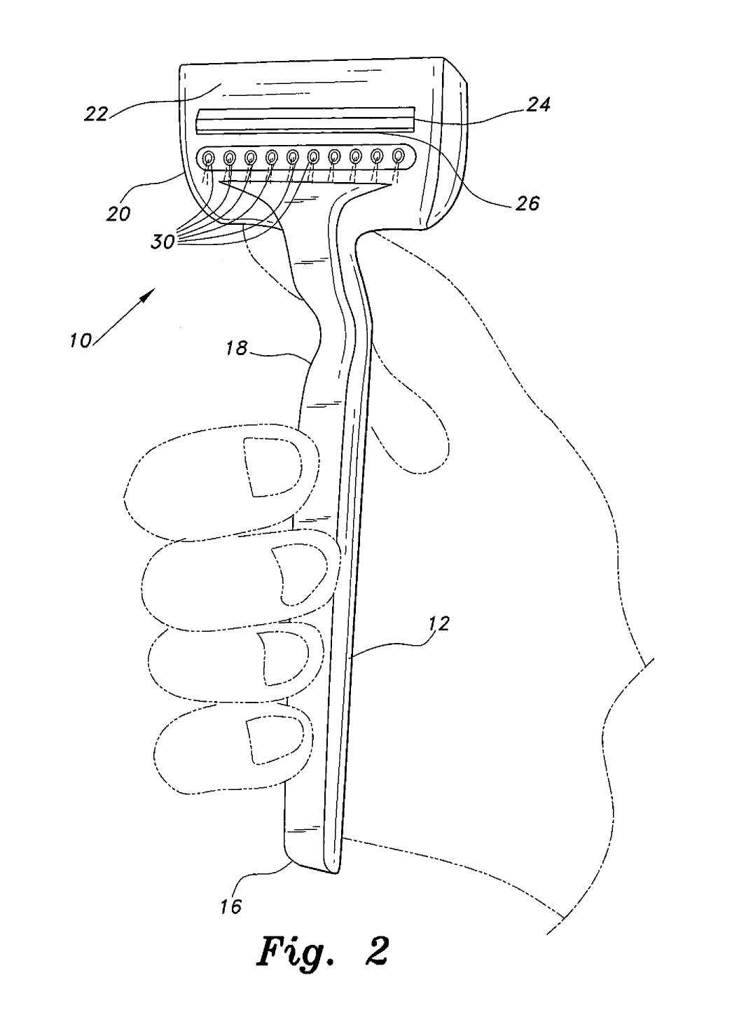

The razor head 20 includes a front face 22 (shown in FIG. 2) having at least one razor blade 24 installed within the head 20, the blade 24 having a cutting edge 26 extending slightly from the head 20, as is conventional in razors. A water channel 28 is disposed within the razor head 20, as shown in FIG. 3. The water passage 14 of the handle 12 is continuous with the water channel 28 within the head 20. The water passage 14 and water channel 28 deliver water to a plurality of water outlet pores 30 disposed laterally across the front face 22 of the razor head 20. The water outlet pores 30 are distributed in a linear array immediately adjacent to and directly in front of the cutting edge 26 of the razor blade 24, i.e., leading the cutting edge 26 of the blade 24 as it is passed over the face of the user of the device. There are preferably a reasonably large number of water outlet pores 30, e.g., ten pores, in order to provide distribution of water completely across the path of the razor blade 24 during shaving.

Adjustment of the water flow through the liquid-dispensing razor 10 provides a constant flow of water to moisten the area of the beard immediately in front of the blade 24, just before the cutting edge 26 of the blade 24 reaches the moistened area. Control of the water flow for the liquid-dispensing razor 10 may be provided by a water flow control valve 32 located at the outflow end 18 of the handle 12 adjacent to the razor head 20. The control valve 32 is preferably located adjacent the back side of the razor head 20, i.e., adjacent the side opposite the razor blade 24, near where the thumb of the user of the razor 10 would be positioned while shaving. This allows the user to manipulate the pushbutton control valve 32 conveniently during shaving.

A number of different means are provided for distributing water to the liquid-dispensing razor 10. In FIG. 1, the inflow end 16 of the razor handle 12 is connected to a conventional water tap T by a flexible water supply line 34. The water supply line 34 may be coiled as shown, in the manner of various hydraulic and pneumatic supply hoses and lines.

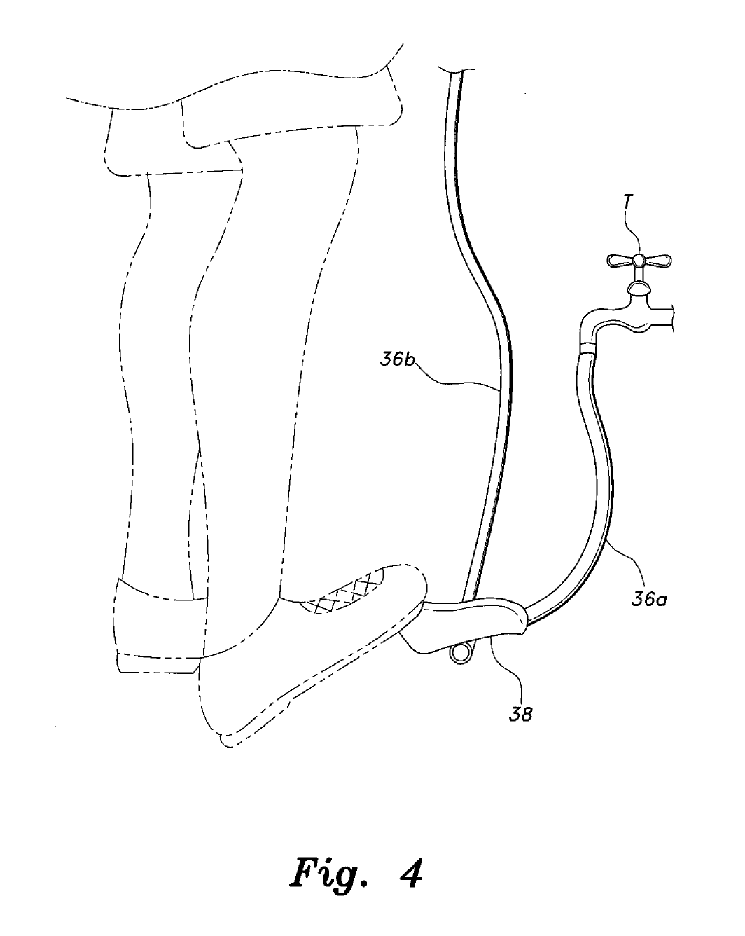

As an alternative to the water control valve 32 illustrated in FIGS. 1 and 3, water flow control may be provided by a remotely actuated valve. An example of such a water flow control system is illustrated in FIG. 4 of the drawings. In FIG. 4, a first length 36a of a flexible water supply hose or line extends from a water tap T to a foot-actuated water flow control valve 38 remotely situated from the razor. A second length 36b extends from the flow control valve 38 to the razor 10. Thus, the user of the liquid-dispensing razor 10 may control the water flow with his foot while shaving, leaving the hands free.

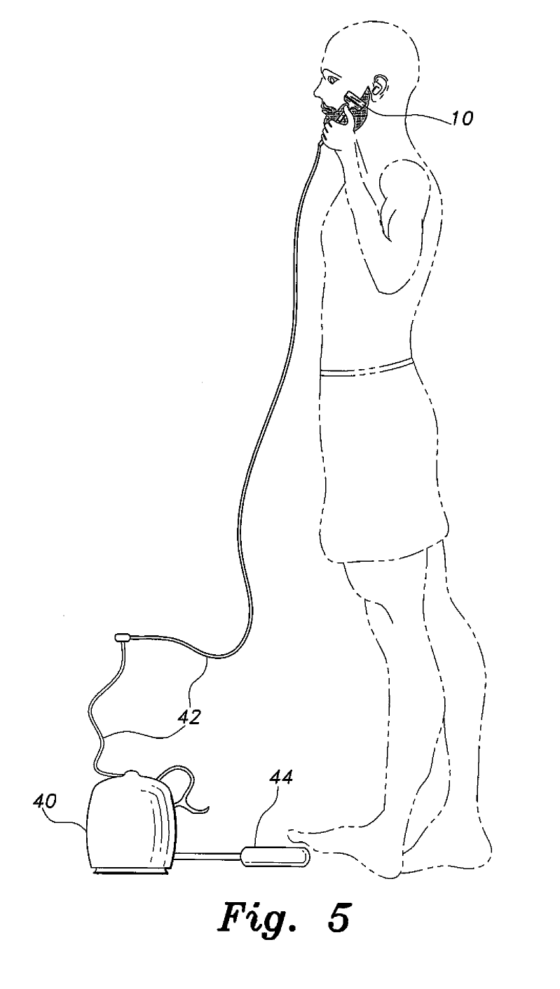

FIG. 5 illustrates another remotely situated water supply for the liquid-dispensing razor 10. In FIG. 5, a portable water container 40 is connected to the razor 10 by a flexible water line 42. The water container 40 may be disposed below the razor 10, and a pneumatic pressure foot pump control 44 may be provided to produce and control the pressure needed to force the water up through the water delivery line 42 to the razor 10. Water flow from the razor 10 may be controlled by the pushbutton flow control 32 illustrated in FIGS. 1 and 3, or by controlling the pneumatic pressure in the portable container 40 according to the operation of the pneumatic pressure pump control 44 on the portable container 40. Alternatively a conventional electrically powered pump may be used to provide the water pressure required.

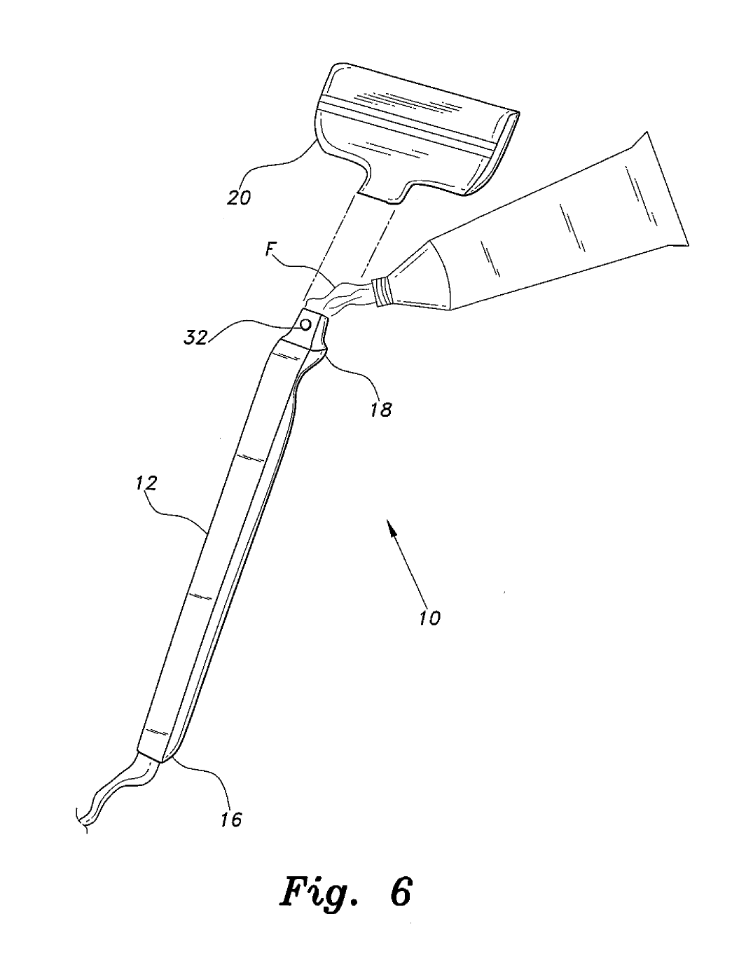

The hollow handle 12 of the liquid-dispensing razor 10 may also be used for the storage and dispensing of fluids other than water. FIG. 6 illustrates the means for placing another fluid F, e.g., a shaving lather or gel, etc., into the hollow handle 12. The head 20 of the razor 10 may be removably attached to the outflow end 18 of the handle 12, e.g., by a friction fit or by conventional mechanical fastening. The head 20 is removed from the handle 12 to expose the open outflow end of the water passage 14 (shown in FIG. 3) within the handle 12. The fluid F is poured or dispensed into the water passage 14 of the handle 12, and the head 20 is reinstalled upon the handle 12. Application of water through the handle 12 entrains the shaving lather, gel, or other fluid in the hollow handle 12 and out the water outlet pores 30 to provide additional lubrication for the beard or other area being shaved.

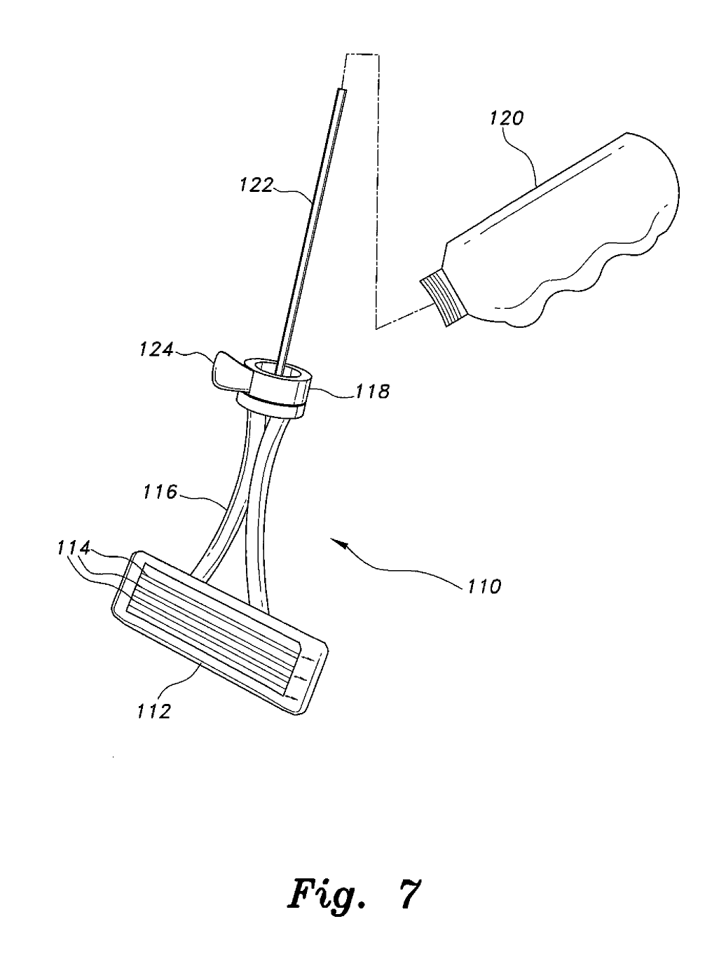

FIG. 7 is an environmental perspective view of another embodiment of the liquid-dispensing razor, which is designated as razor 110. The razor 110 includes a multiple blade head 112 having a plurality of razor blades 114 therein. Water (or other fluid) passages extend through the shank portion 116 of the razor to distribute water or other fluid through pores in the razor head 112. These passages and pores are not shown in FIG. 7, but will be understood to be much like the passage 14 shown in FIG. 3 and the pores 30 shown in FIG. 2 for the first razor embodiment 10.

The shank portion 116 of the razor 110 terminates in an attachment fitting 118, and a water (or other fluid) container 120 is removably attached to the razor 110 by means of its attachment fitting 118. The container 120 is shaped or configured to serve as a handle for the razor 110. A pickup tube 122 extends from the attachment fitting 118 and communicates fluidly with the passages through the shank portion 116 of the razor 110. The pickup tube 122 extends to the bottom of the container 120 to draw fluid therefrom when the container 120 is assembled to the razor 110. A pushbutton actuator 124 is located on the attachment fitting 118. The actuator button 124 may comprise a small conventional pneumatic one-way valve or pump to pressurize the interior of the fluid container 120. The slight pressurization provided by such a mechanism forces the water or other liquid within the container 120 up through the pickup tube 122 and out through the razor head 112, generally in the manner described further above for the liquid-dispensing razor 10 of FIGS. 1 through 3.

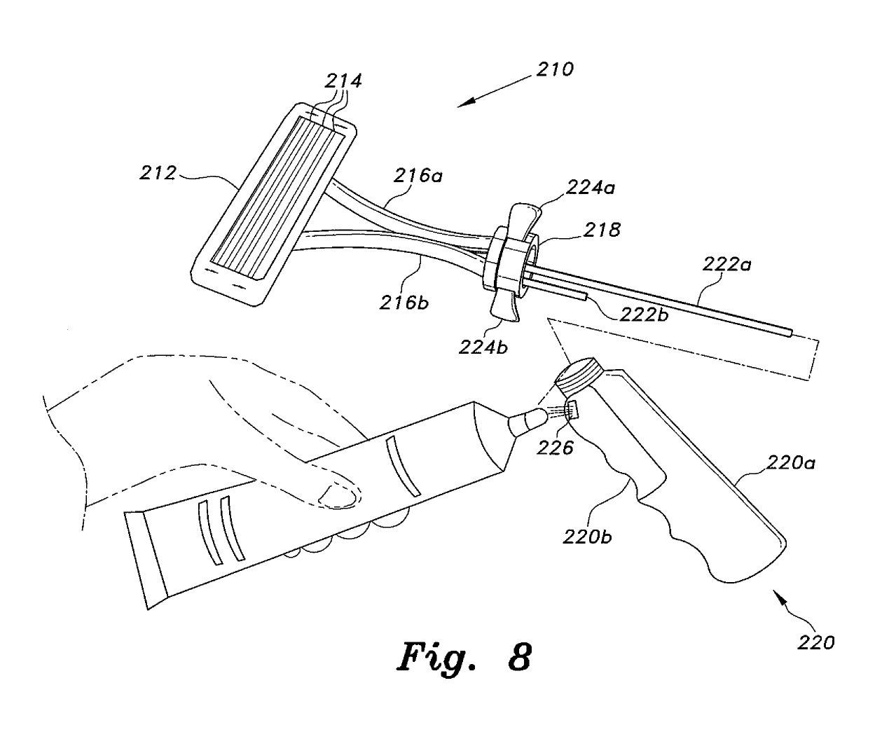

FIG. 8 provides an environmental perspective view of another liquid-dispensing razor embodiment, designated as razor 210. The razor 210 includes a head 212 having a plurality of blades 214, in a similar manner to the razor 110 of FIG. 7. However, the members of the shank portion comprise separate fluid passages 216a and 216b, rather than being a shank with a divided common passage as in the razor 110 of FIG. 7. The two passages 216a and 216b may be contained within a single shank structure, if desired.

The shank passages 216a, 216b terminate in an attachment fitting 218, which provides removable attachment of the razor 210 to a fluid container 220. The container 220 includes two separate fluid-containing compartments, i.e., a larger compartment 220a and a smaller compartment 220b. A longer pickup tube 222a communicates fluidly with the first shank passage 216a and extends to the bottom of the larger first container compartment 220a when the container 220 is assembled to the razor 210. A shorter pickup tube 222b communicates fluidly with the second shank passage 216b and extends to the bottom of the smaller second container compartment 220b when the container 220 is assembled to the razor 210. The attachment fitting 218 includes first and second pushbutton actuators 224a and 224b that operate separately and independently of one another to pressurize either of the two compartments 220a or 220b, as desired. These actuators 224a and 224b use conventional pneumatic mechanisms in the manner of the actuator 124 described further above for the razor embodiment 110 of FIG. 7. Water or other fluid may be poured into the larger compartment 220a of the container 220 through the conventional neck opening of the container, and a shaving gel (or other fluid) is introduced into the second compartment 220b through an appropriate opening 226, generally as shown in FIG. 8.

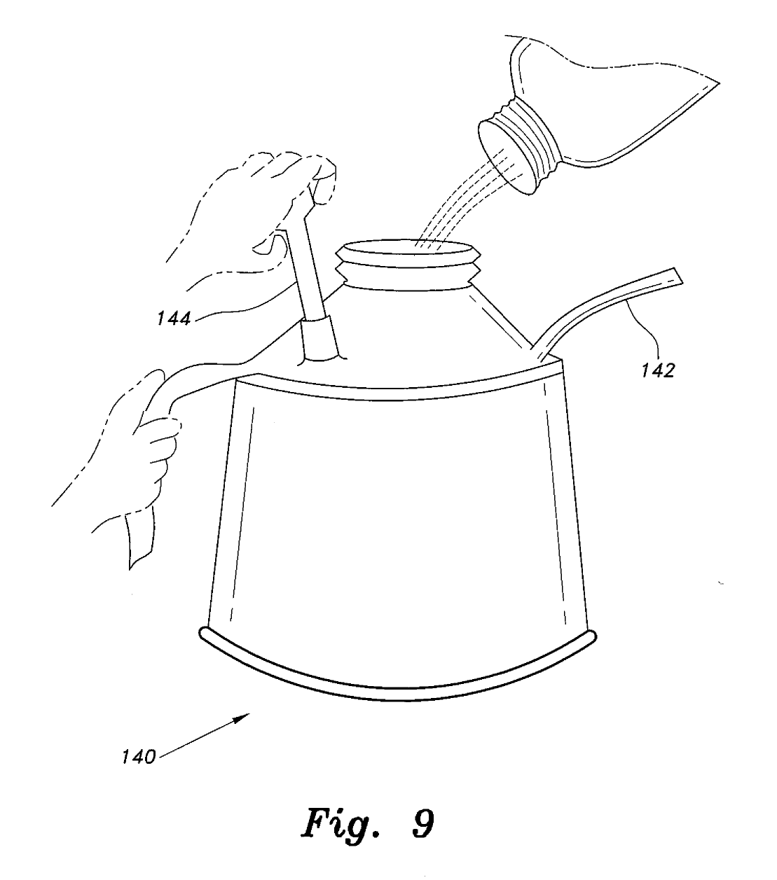

FIG. 9 of the drawings provides an illustration of an alternative portable water (or other fluid) container, designated as container 140. The container 140 is similar to the container 40 of FIG. 5, but rather than having a foot-actuated pneumatic pump, the container 140 has a pneumatic hand pump 144 to pressurize the container 140. Water (or other liquid) is poured into the container 140 through its conventional top opening, which is sealed by a conventional lid (not shown). The container 140 is pressurized pneumatically by means of the hand pump 144, so that the pressure forces the water (or other fluid) from the container and out the water or fluid line 142 to the razor, e.g., the razor 10 of FIGS. 1 through 3.

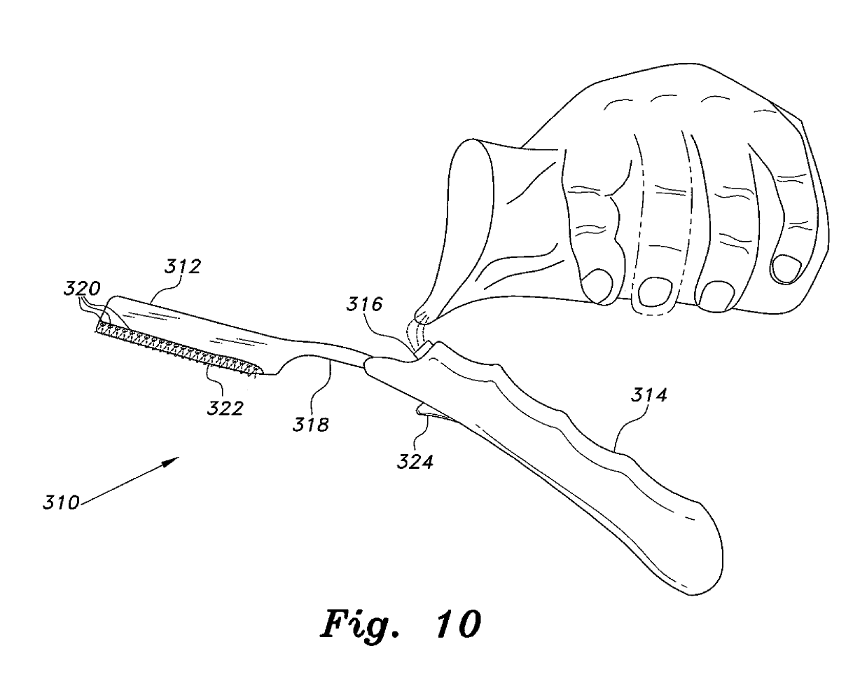

FIG. 10 illustrates another embodiment comprising a straight razor configuration. The straight razor 310 includes an elongate blade 312 extending a handle 314, the configuration being generally similar to the classical or conventional straight razor configuration that has been known for a considerable period of time. However, the handle 314 is hollow, much like the razor handle 12 of the razor 10 of FIGS. 1 through 3. The hollow handle 314 provides a reservoir for water or other fluid therein, which is introduced into the handle through a filler opening 316 therein. The filler opening 316 is sealed by a conventional cap or lid to contain pressure within the reservoir of the handle 314. The razor blade 312 may fold into the handle 314, but the cavity for storage of the folded blade must be offset or otherwise positioned in order to avoid impinging upon the fluid cavity within the handle 314.

A hollow shank 318 extends from the blade 312 to connect the blade to the handle 314. The shank 318 communicates fluidly with the cavity within the hollow handle 314, so that fluid flows from the handle through the shank 318 to the blade 312. The blade 312 includes a hollow longitudinal passage therethrough, which communicates fluidly with the hollow shank 318, and also with a plurality of outlet pores 320 disposed adjacent to the cutting edge 322 of the blade 312. The straight razor 310 is used by filling the reservoir or cavity within the hollow handle 314 with water or other fluid, generally as shown in FIG. 10, and sealing the reservoir with a cap or top, as is conventional in such fluid containers. The interior of the handle 314 is pneumatically pressurized by a small pushbutton pump 324 on the handle 314, the pump 324 operating conventionally in the manner described further above for the small pneumatic pumps 124 (FIG. 7) and 224a, 224b (FIG. 8). The pressure within the handle 314 forces the fluid therein out through the hollow shank 318 and through the hollow longitudinal passage through the blade 312, and out the pores 320 along the cutting edge 322 of the blade to lubricate the skin of the person using the razor 310 as he is shaving.

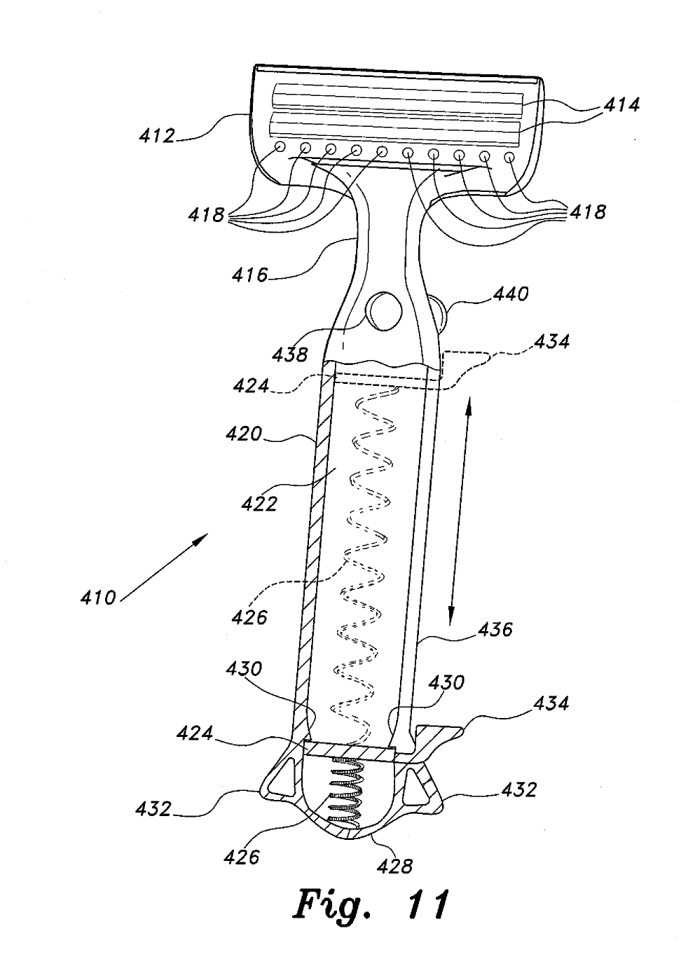

FIG. 11 provides an illustration of yet another embodiment of a liquid-dispensing razor, comprising a safety razor 410 having a hollow handle for the containment of water, shaving cream, and/or other liquid. The razor 410 includes a head 412 having one or more razor blades 414 therein. Liquid passages extend through the shank portion 416 of the razor to distribute water or other fluid through pores 418 in the razor head 412. These liquid passages are essentially similar to the passage 14 extending through the handle 12 of the razor 10 illustrated in FIG. 3.

The safety razor 410 includes a hollow handle portion 420 extending from the shank 416. The handle 420 includes an internal liquid storage cavity 422 therein. A plunger 424 of elastomer or other suitable material is slidingly disposed within the handle storage cavity 422, the edges of the plunger 424 making a good seal with the internal walls of the hollow handle 420. A spring 426 is seated in the distal end 428 of the hollow handle 420 and compressively urges the plunger 424 through the storage cavity 422 toward the head 412 of the razor 410. The plunger 424 may be retained near the distal end 428 of the handle 420 by latches 430 extending inwardly from the inner walls of the hollow handle 420 near the distal end 428 thereof. The latches 430 may be selectively released by pressure on the external tabs 432 that extend from the handle 420 near the distal end 428 thereof, thereby allowing the spring 426 to push the plunger 424 through the internal cavity 422 of the handle 420 to expel any fluid therein from the pores 418 of the razor head. A retraction lever 434 extends from the edge of the plunger 424, the extension or connection between the plunger 424 and lever 434 traveling in a slot 436 formed along the side of the handle 420.

The razor 410 is used by first retracting the spring 426 and plunger 424 by means of the retraction lever 434 and capturing the plunger 424 with the internal latches 430 to maximize the internal volume 422 of the handle 420 between the plunger 424 and the shank portion 416. A filler port and cap 438 for filling the handle 420 is provided at the juncture of the handle 420 and shank 416. The cap 438 is removed and the internal volume 422 of the handle 420 is filled with shaving cream, foam, gel, or other liquid. The cap 438 is then replaced, and the plunger 424 is released by manipulating the external release tabs 432 adjacent the distal end 428 of the handle 420 to pressurize the contents of the handle 420 by means of the spring 426 and plunger 424. A dispensing control valve 440 of conventional configuration is provided at the juncture of the handle 420 and shank 416. Operation of the valve 440 opens the passage from the internal volume 422 of the handle 420 through the shank 416 to the dispensing pores 418 of the razor head 412, thereby dispensing the liquid from the pores 418 as the spring 426 and plunger 424 urge the liquid within the internal volume 422 of the handle 420 toward the razor head 412.

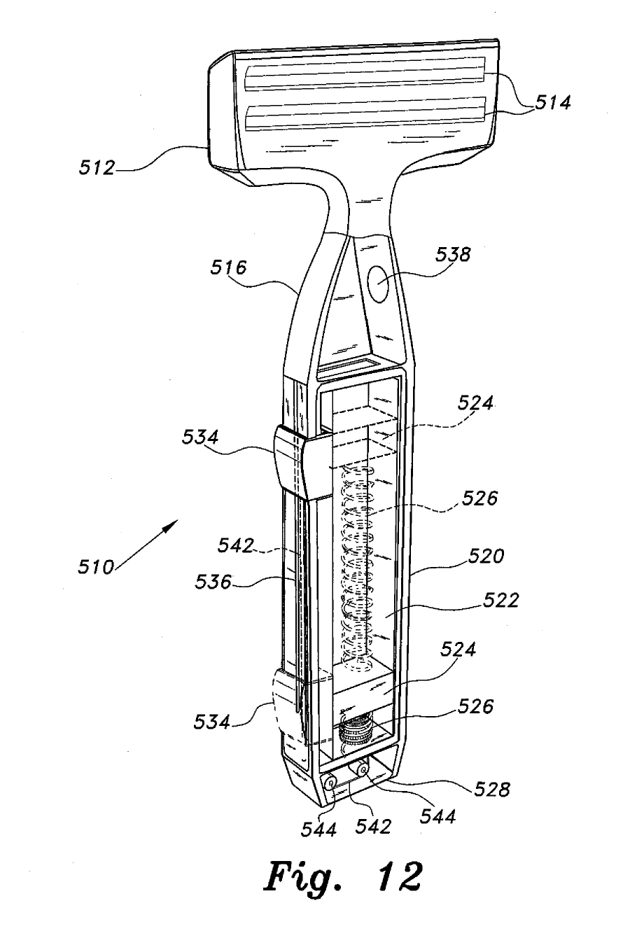

FIG. 12 provides an illustration of a further embodiment of a liquid-dispensing razor, comprising a safety razor 510 having a hollow handle for the containment of water, shaving cream, and/or other liquid. The razor 510 includes a head 512 having one or more razor blades 514 therein. Liquid passages extend through the shank portion 516 of the razor to distribute water or other fluid through pores in the razor head 512. These liquid passages and pores are essentially similar to the passage 14 extending through the handle 12 of the razor 10 illustrated in FIG. 3 and pores 418 of the razor 410 of FIG. 11.

The safety razor 510 includes a hollow handle portion 520 extending from the shank 516. The handle 520 includes an internal liquid storage cavity 522 therein. A plunger 524 of elastomer or other suitable material is slidingly disposed within the handle storage cavity 522, the edges of the plunger 524 making a good seal with the internal walls of the hollow handle 520. A spring 526 is seated in the distal end 528 of the hollow handle 520 and compressively urges the plunger 524 through the storage cavity 522 toward the head 512 of the razor 510.

The dispensing mechanism of the razor 510 differs from that of the razor 410 in that the lever or slide 534 along the side of the handle 520 is not directly connected to the plunger 524 within the handle. The slide or lever 534 rides or slides in a slot 536 through the side of the handle 520, and is connected to a cable, cord, or the like 542 that extends toward the distal end 528 of the handle to pass around a pair of rollers or pulleys 544 disposed within the distal end 528 of the handle, thence continuing up to attach to the bottom of the plunger 524, i.e., to the same side of the plunger 524 that bears against the spring 526. The at-rest positions of the plunger 524 and slide or lever 534 are shown in broken lines in FIG. 12, and the compressive spring 526 is also shown in broken lines in its fully extended state.

The razor 510 is used by first retracting the spring 526 and plunger 524 by sliding the slide or lever 534 from its rest position near the distal end 528 of the handle 520 to its position as shown in solid lines near the shank 516 of the razor 510. This draws the cable or cord 542 upward along the slot 536, thereby drawing the cable 542 around the rollers or pulleys 544 to draw the plunger 524 to a position shown in solid lines toward the distal end 528 of the handle 520, thereby compressing the spring 526, as shown in solid lines in FIG. 12. The internal volume 522 of the handle 520 may then be filled with shaving cream, foam, gel, or other liquid through the cap 538. The cap 538 is then replaced, and the plunger 524 is released by releasing the slide or lever 534 from the position shown in broken lines to allow the spring 526 to push the plunger 524 toward the razor head 512, thereby forcing the liquid contained within the handle 520 up through the shank 516 and razor head 512 and out through the pores (as shown in FIG. 11) of the razor head 512 to moisten the beard of the user of the razor 510.

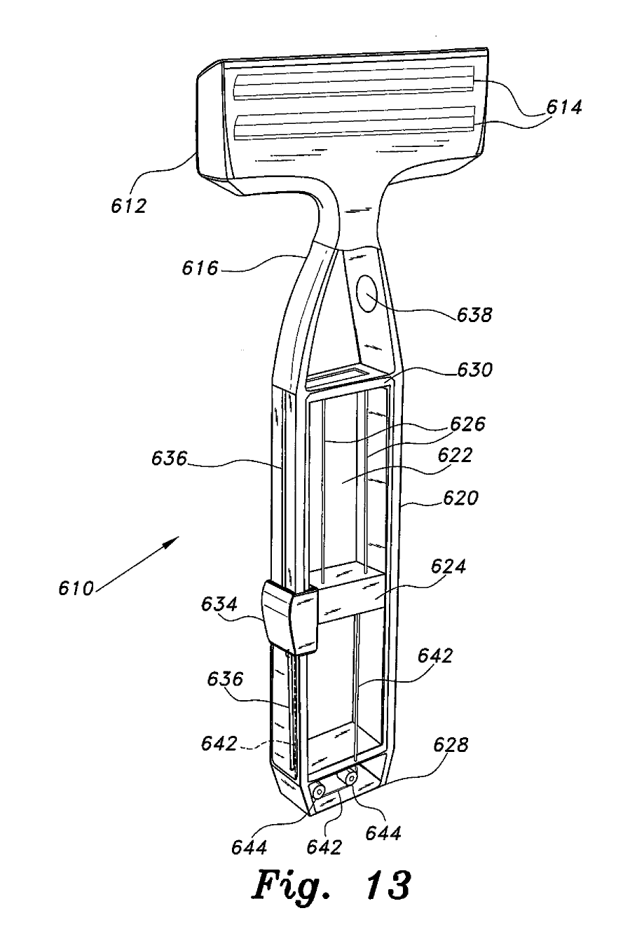

FIG. 13 provides an illustration of a further embodiment of a liquid-dispensing razor, comprising a safety razor 610 having a hollow handle for the containment of water, shaving cream, and/or other liquid. The razor 610 includes a head 612 having one or more razor blades 614 therein. Liquid passages extend through the shank portion 616 of the razor to distribute water or other fluid through pores in the razor head 612. These liquid passages and pores are essentially similar to the passage 14 extending through the handle 12 of the razor 10 illustrated in FIG. 3 and pores 418 of the razor 410 of FIG. 11.

The safety razor 610 includes a hollow handle portion 620 extending from the shank 616. The handle 620 includes an internal liquid storage cavity 622 therein. A plunger 624 of elastomer or other suitable material is slidingly disposed within the handle storage cavity 622, the edges of the plunger 624 making a good seal with the internal walls of the hollow handle 620. One or more elastic bands or cords 626 extend from the plunger 624 to the upper end 630 of the hollow cavity or chamber 622 and draw the plunger 624 through the storage cavity 622 toward the head 612 of the razor 610.

The dispensing mechanism of the razor 610 differs from that of the razor 610. Rather than using a compressive spring, the razor 610 uses one or more elastomer bands or cords in tension. The slide or lever 634 rides or slides in a slot 636 through the side of the handle 620 and is connected to a cable, cord, or the like 642 that extends toward the distal end 628 of the handle to pass around a pair of rollers or pulleys 644 disposed within the distal end 628 of the handle, thence continuing up to attach to the bottom of the plunger 624, i.e., to the opposite side of the plunger from that connected to the elastomer cord(s) 626.

The razor 610 is used by first extending the elastomer cord(s) 626 and drawing the plunger 624 toward the distal end 628 of the handle 620 by sliding the slide or lever 634 from its rest position near the distal end 628 of the handle 620 to a position near the shank 616 of the razor 610. (The slide or lever 634 and plunger 624 are illustrated at an intermediate position in FIG. 13.) This draws the cable or cord 642 upward along the slot 636, thereby drawing the cable 642 around the rollers or pulleys 644 to draw the plunger 624 toward the distal end 628 of the handle 620, thereby extending the elastomer cord(s) 626. The internal volume 622 of the handle 620 may then be filled with shaving cream, foam, gel, or other liquid through the cap 638. The cap 638 is then replaced, and the plunger 624 is released by releasing the slide or lever 634 from its position shown in broken lines to allow the elastomer cord(s) 626 to draw the plunger 624 toward the razor head 612, thereby forcing the liquid contained within the handle 620 up through the shank 616 and razor head 612 and out through the pores (as shown in FIG. 11) of the razor head 612 to moisten the beard of the user of the razor 610.

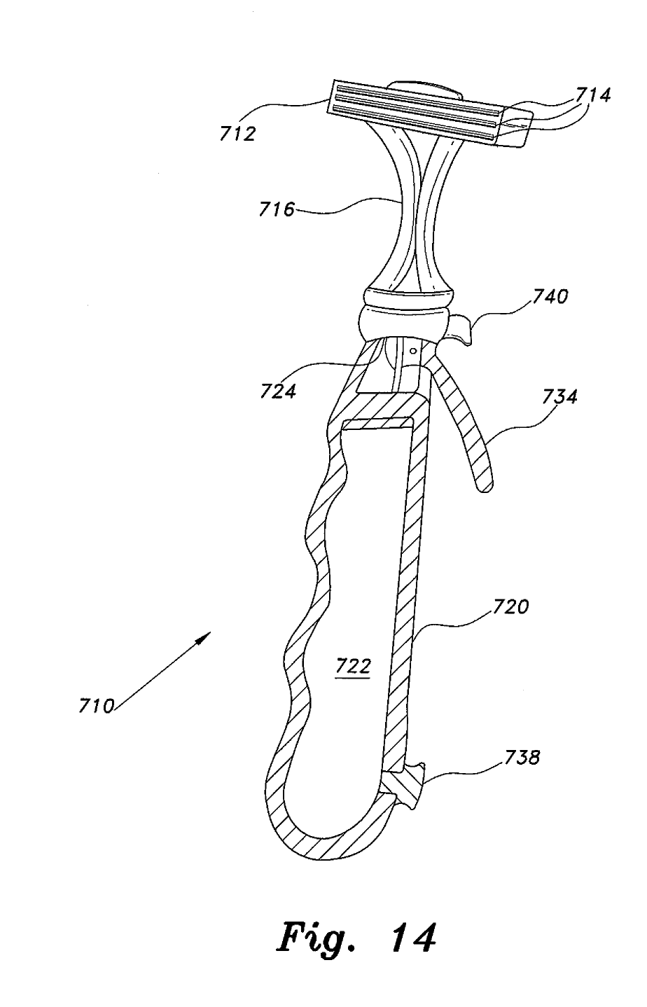

FIG. 14 provides an illustration of a further embodiment of a liquid-dispensing razor, comprising a safety razor 710 having a hollow handle for the containment of water, shaving cream, and/or other liquid. The razor 710 includes a head 712 having one or more razor blades 714 therein. Liquid passages extend through the shank portion 716 of the razor to distribute water or other fluid through pores in the razor head 712. These liquid passages and pores are essentially similar to the passage 14 extending through the handle 12 of the razor 10 illustrated in FIG. 3 and pores 418 of the razor 410 of FIG. 11.

The safety razor 710 includes a hollow handle portion 720 extending from the shank 716. The handle 720 includes an internal liquid storage cavity 722 therein. Rather than using a plunger and other mechanism to urge or force liquid within the handle up toward the razor head, the safety razor 710 uses a small manually operated pneumatic pump 724 of conventional mechanism to pressurize the interior volume 722 of the handle 720. The pump 724 may be operated by using the thumb or finger to operate a lever 734. Prior to pressurizing the internal volume 722 of the handle 720, the internal volume 722 of the handle 720 may be filled with shaving cream, foam, gel, or other liquid through the cap (not shown in FIG. 14, but similar to e.g., the cap 440 of the liquid-dispensing razor 410 of FIG. 11). The cap is then replaced, and the pump 724 is actuated by means of the lever 734, thereby pressurizing the interior volume 722 of the handle 720 and forcing the liquid contained within the handle 720 up through the shank 716 and razor head 712 and out through the pores (as shown in FIG. 11) of the razor head 712 to moisten the beard of the user of the razor 710. Control of the amount of liquid dispensed is provided by means of a dispensing control valve 740 of conventional configuration disposed at the pump 724, at the juncture of the handle 720 and shank 716. The control valve 740 may be of similar configuration to that of the valve 440 of the razor 410 of FIG. 11.

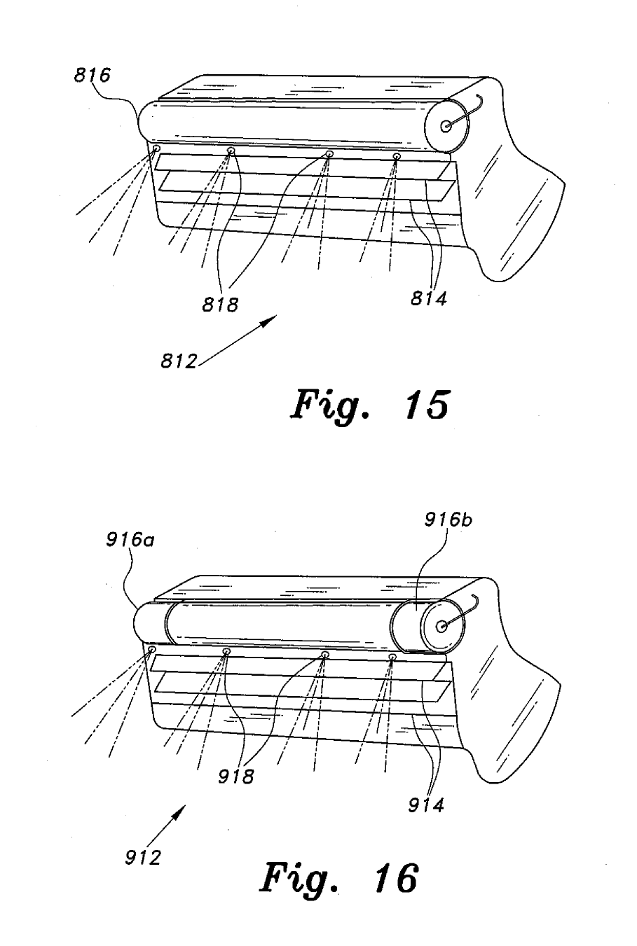

FIG. 15 of the drawings provides a detailed perspective view of an alternative embodiment of the razor head, designated as razor head 812. The razor head 812 includes one or more blades 814 and a plurality of-liquid dispensing or outflow pores 818, as in the case of the other razor embodiments described herein. The razor head 812 further includes a roller 816 disposed laterally thereacross, extending from one end or edge to the opposite end or edge of the razor head 812 parallel to the blade(s) 814. The roller 816 serves to reduce frictional drag as the razor head 812 slides over the skin and beard of the user. The razor head 812 and roller 816 may be applied to any of the safety razor embodiments described herein, if desired.

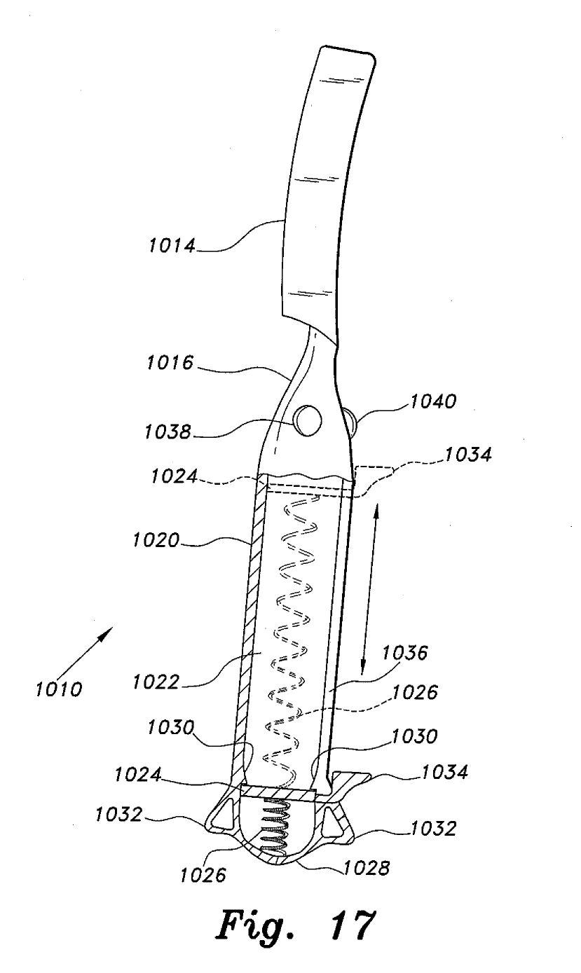

FIG. 16 of the drawings provides a detailed perspective view of another alternative embodiment of the razor head, designated as razor head 912. The razor head 912 is similar to the roller razor head 812 of FIG. 15, having one or more blades 914 and a plurality of liquid-dispensing or outflow pores 918, as in the case of the other razor embodiments described herein. The razor head 912 differs from the razor head 812 by having two laterally spaced rollers 916a and 916b, which are positioned at the laterally opposite ends of the razor head 914. The roller axes of the two rollers 916a and 916b are concentric with one another and parallel to the blade(s) 914. A fixed, non-rotating span is positioned between the two rollers 916a and 916b. The two rollers 916a and 916b serve to reduce frictional drag as the razor head 912 slides over the skin and beard of the user. The razor head 912 and the two rollers 916a and 916b may be applied to any of the safety razor embodiments described herein, if desired.

The various dispensing embodiments of FIGS. 11 through 14 may be applied to straight razors as well. FIG. 17 provides an illustration of yet another embodiment of a liquid-dispensing razor, comprising a straight razor 1010 having a hollow handle for the containment of water, shaving cream, and/or other liquid. This embodiment may be considered to be a combination of the straight razor component 312 of FIG. 10 and the liquid-dispensing handle portion 420 of the safety razor 410 of FIG. 11. The razor 1010 includes a straight razor blade 1014 connected to the handle portion by a shank 1016. A liquid passage extends through the shank portion 1016 of the straight razor 1010 to distribute water or other fluid through pores 1018 in the razor 1010. These liquid passages and pores are essentially similar to the passage 14 extending through the handle 12 of the razor 10 illustrated in FIG. 3 and the pores 320 of the straight razor 312 of FIG. 10,

The straight razor 1010 includes a hollow handle portion 1020 extending from the shank 1016. The handle 1020 includes an internal liquid storage cavity 1022 therein. A plunger 1024 of elastomer or other suitable material is slidingly disposed within the handle storage cavity 1022, the edges of the plunger 1024 making a good seal with the internal walls of the hollow handle 1020. A spring 1026 is seated in the distal end 1028 of the hollow handle 1020, and compressively urges the plunger 1024 through the storage cavity 1022 toward the blade 1014 of the straight razor 1010. The plunger 1024 may be retained near the distal end 1028 of the handle 1020 by latches 1030 extending inwardly from the inner walls of the hollow handle 1020 near the distal end 1028 thereof. The latches 1030 may be selectively released by pressure on the external tabs 1032 that extend from the handle 1020 near the distal end 1028 thereof, thereby allowing the spring 1026 to push the plunger 1024 through the internal cavity 1022 of the handle 1020 to expel any fluid therein from the pores of the straight razor blade 1014. A retraction lever 1034 extends from the edge of the plunger 1024, the extension or connection between the plunger 1024 and lever 1034 traveling in a slot 1036 formed along the side of the handle 1020.

The straight razor 1010 is used by first retracting the spring 1026 and plunger 1024 by means of the retraction lever 1034 and capturing the plunger 1024 with the internal latches 1030 to maximize the internal volume 1022 of the handle 1020 between the plunger 1024 and the shank portion 1016. A filler port and cap 1038 for filling the handle 1020 is provided at the juncture of the handle 1020 and shank 1016. The cap 1038 is removed and the internal volume 1022 of the handle 1020 is filled with shaving cream, foam, gel, or other liquid. The cap 1038 is then replaced, and the plunger 1024 is released by manipulating the external release tabs 1032 adjacent the distal end 1028 of the handle 1020 to pressurize the contents of the handle 1020 by means of the spring 1026 and plunger 1024. A dispensing control valve 1040 of conventional configuration is provided at the juncture of the handle 1020 and shank 1016. Operation of the valve 1040 opens the passage from the internal volume 1022 of the handle 1020 through the shank 1016 to the dispensing pores of the straight razor blade 1012, thereby dispensing the liquid from the pores as the spring 1026 and plunger 1024 urge the liquid within the internal volume 1022 of the handle 1020 toward the razor blade 1012.

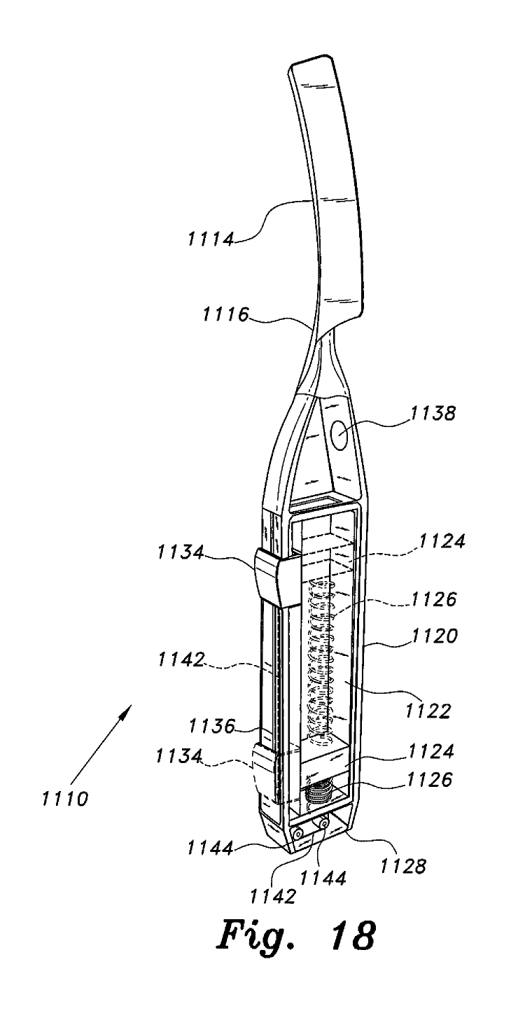

FIG. 18 provides an illustration of a further embodiment of a liquid-dispensing razor, comprising a straight razor blade 1114 having a hollow handle for the containment of water, shaving cream, and/or other liquid. This embodiment may be considered to be a combination of the straight razor component 312 of FIG. 10 and the liquid dispensing handle portion 520 of the safety razor 510 of FIG. 12. The razor 1110 includes a straight blade 1114, as noted above. Liquid passages extend through the shank portion 1116 of the razor to distribute water or other fluid through pores in the razor blade 1114. These liquid passages and pores are essentially similar to the passage 14 extending through the handle 12 of the razor 10 illustrated in FIG. 3 and pores 418 of the razor 410 of FIG. 11.

The straight razor 1110 includes a hollow handle portion 1120 extending from the shank 1116. The handle 1120 includes an internal liquid storage cavity 1122 therein. A plunger 1124 of elastomer or other suitable material is slidingly disposed within the handle storage cavity 1122, the edges of the plunger 1124 making a good seal with the internal walls of the hollow handle 1120. A spring 1126 is seated in the distal end 1128 of the hollow handle 1120 and compressively urges the plunger 1124 through the storage cavity 1122 toward the head 1112 of the razor 1110.

The dispensing mechanism of the razor 1110 differs from that of the razor 1010 in that the lever or slide 1134 along the side of the handle 1120 is not directly connected to the plunger 1124 within the handle. The slide or lever 1134 rides or slides in a slot 1136 through the side of the handle 1120 and is connected to a cable, cord, or the like 1142 that extends toward the distal end 1128 of the handle to pass around a pair of rollers or pulleys 1144 disposed within the distal end 1128 of the handle, thence continuing up to attach to the bottom of the plunger 1124, i.e., to the same side of the plunger that bears against the spring 1126. The at-rest positions of the plunger 1124 and slide or lever 1134 are shown in broken lines in FIG. 18, and the compressive spring 1126 is also shown in broken lines in its fully extended state.

The razor 1110 is used by first retracting the spring 1126 and plunger 1124 by sliding the slide or lever 1134 from its rest position near the distal end 1128 of the handle 1120 to its position as shown in solid lines near the shank 1116 of the razor 1110. This draws the cable or cord 1142 upward along the slot 1136, thereby drawing the cable 1142 around the rollers or pulleys 1144 to draw the plunger 1124 to a position shown in solid lines toward the distal end 1128 of the handle 1120, thereby compressing the spring 1126, as shown in solid lines in FIG. 18. The internal volume 1122 of the handle 1120 may then be filled with shaving cream, foam, gel, or other liquid through the cap 1138. The cap 1138 is then replaced, and the plunger 1124 is released by releasing the slide or lever 1134 from its position shown in broken lines to allow the spring to push the plunger 1124 toward the razor head 1112, thereby forcing the liquid contained within the handle 1120 up through the shank 1116 and razor head 1112 and out through the pores (as shown in FIG. 11) of the razor head 1112 to moisten the beard of the user of the razor 1110.

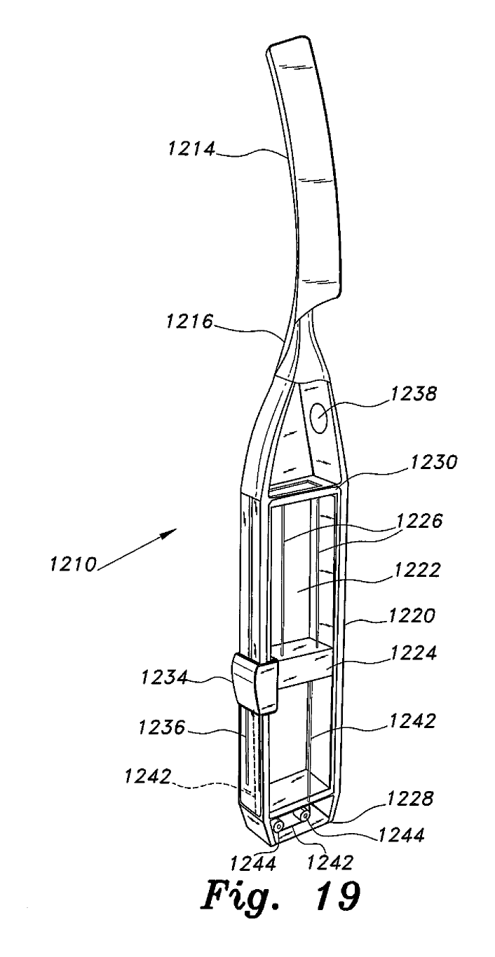

FIG. 19 provides an illustration of a further embodiment of a liquid-dispensing razor, comprising a straight razor blade 1214 having a hollow handle for the containment of water, shaving cream, and/or other liquid. This embodiment may be considered to be a combination of the straight razor component 312 of FIG. 10 and the liquid dispensing handle portion 620 of the safety razor 610 of FIG. 13. The razor 1210 includes a straight blade 1214, as noted above. Liquid passages extend through the shank portion 1216 of the razor to distribute water or other fluid through pores in the razor blade 1214. These liquid passages and pores are essentially similar to the passage 14 extending through the handle 12 of the razor 10 illustrated in FIG. 3 and pores 418 of the razor 410 of FIG. 11.

The straight razor 1210 includes a hollow handle portion 1220 extending from the shank 1216. The handle 1220 includes an internal liquid storage cavity 1222 therein. A plunger 1224 of elastomer or other suitable material is slidingly disposed within the handle storage cavity 1222, the edges of the plunger 1224 making a good seal with the internal walls of the hollow handle 1220. One or more elastic bands or cords 1226 extend from within the distal end 1228 of the hollow handle 1220 to the upper end 1230 of the hollow cavity or chamber 1222 and draw the plunger 1224 through the storage cavity 1222 toward the head 1212 of the razor 1210.

The dispensing mechanism of the razor 1210 differs from that of the razor 1110. Rather than using a compressive spring, the razor 1210 uses one or more elastomer bands or cords in tension. The slide or lever 1234 rides or slides in a slot 1236 through the side of the handle 1220, and is connected to a cable, cord, or the like 1242 that extends toward the distal end 1228 of the handle to pass around a pair of rollers or pulleys 1244 disposed within the distal end 1228 of the handle, thence continuing up to attach to the bottom of the plunger 1224, i.e., to the opposite side of the plunger 1224 from that connected to the elastomer cord(s) 1226.

The razor 1210 is used by first extending the elastomer cord(s) 1226 and drawing the plunger 1224 toward the distal end 1228 of the handle 1220 by sliding the slide or lever 1234 from its rest position near the distal end 1228 of the handle 1220 to a position near the shank 1216 of the razor 1210. (The slide or lever 1234 and plunger 1224 are illustrated at an intermediate position in FIG. 19.) This draws the cable or cord 1242 upward along the slot 1236, thereby drawing the cable 1242 around the rollers or pulleys 1244 to draw the plunger 1224 toward the distal end 1228 of the handle 1220, thereby extending the elastomer cord(s) 1226. The internal volume 1222 of the handle 1220 may then be filled with shaving cream, foam, gel, or other liquid through the cap 1238. The cap 1238 is then replaced, and the plunger 1224 is released by releasing the slide or lever 1234 from its position shown in broken lines to allow the elastomer cord(s) 1226 to draw the plunger 1224 toward the razor head 1212, thereby forcing the liquid contained within the handle 1220 up through the shank 1216 and razor head 1212 and out through the pores of the razor head 1212 to moisten the beard of the user of the razor 1210.

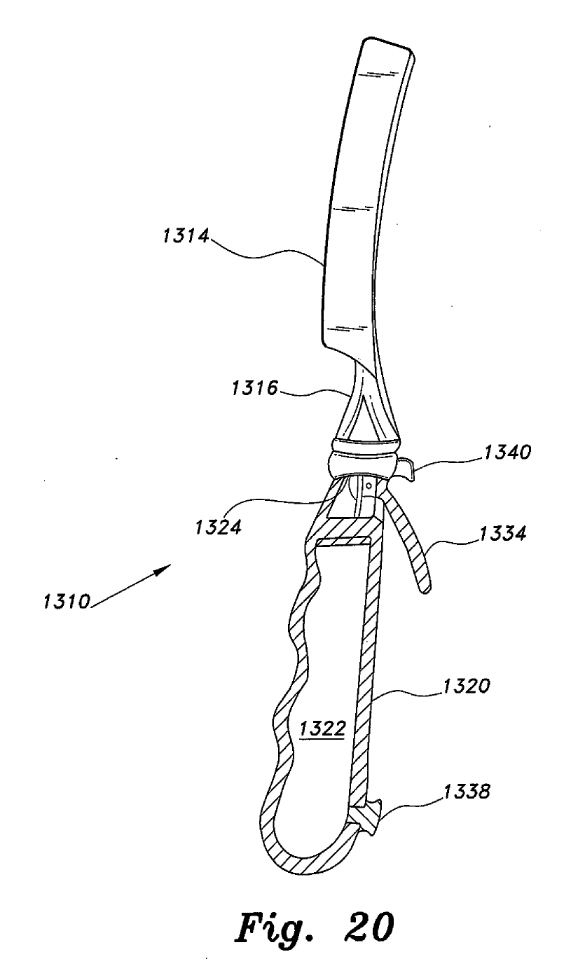

FIG. 20 provides an illustration of a further embodiment of a liquid-dispensing razor, comprising a straight razor blade 1314 having a hollow handle for the containment of water, shaving cream, and/or other liquid. This embodiment may be considered to be a combination of the straight razor component 312 of FIG. 10 and the liquid dispensing handle portion 720 of the safety razor 710 of FIG. 14. The razor 1310 includes a straight blade 1314, as noted above. Liquid passages extend through the shank portion 1316 of the razor to distribute water or other fluid through pores in the razor blade 1314. These liquid passages and pores are essentially similar to the passage 14 extending through the handle 12 of the razor 10 illustrated in FIG. 3 and pores 418 of the razor 410 of FIG. 11.

The straight razor 1310 includes a hollow handle portion 1320 extending from the shank 1316. The handle 1320 includes an internal liquid storage cavity 1322 therein. Rather than using a plunger and other mechanism to urge or force liquid within the handle up toward the razor head, the straight razor 1310 uses a small manually operated pneumatic pump 1324 of conventional mechanism to pressurize the interior volume 1322 of the handle 1320. The pump 1324 may be operated by using the thumb or finger to operate a lever 1334. Prior to pressurizing the internal volume 1322 of the handle 1320, the internal volume 1322 of the handle 1320 may be filled with shaving cream, foam, gel, or other liquid through the cap (not shown in FIG. 20, but similar to e.g., the cap 440 of the liquid-dispensing razor 410 of FIG. 11). The cap is then replaced and the pump 1324 is actuated by means of the lever 1334, thereby pressurizing the interior volume 1322 of the handle 1320 and forcing the liquid contained within the handle 1320 up through the shank 1316 and razor head 1312 and out through the pores (as shown in FIG. 11) of the razor blade 1314 to moisten the beard of the user of the razor 1310. Control of the amount of liquid dispensed is provided by means of a dispensing control valve 1340 of conventional configuration disposed at the pump 1324, at the juncture of the handle 1320 and shank 1316. The control valve 1340 may be of similar configuration to that of the valve 440 of the razor 410 of FIG. 11.

It is to be understood that the present invention is not limited to the embodiments described above, but encompasses any and all embodiments within the scope of the following claims.

I claim:

1. A liquid-dispensing razor, comprising:
an elongate hollow handle defining a water passage therethrough, the handle having an inflow end and an outflow end opposite the inflow end;
a razor head disposed upon the outflow end of the handle, the head having a water channel defined therein, the water channel communicating with the water passage of the handle, the head further having a plurality of water outlet pores defined therein, the water outlet pores communicating with the water channel in the razor head; and
at least one razor blade installed within the razor head, the at least one razor blade having a cutting edge extending slightly from the razor head, the pores in the razor head being distributed in a linear array immediately adjacent and in front of the cutting edge of the razor blade.

2. The liquid-dispensing razor according to claim 1 further comprising a water flow control valve disposed at the outflow end of the handle adjacent the razor head and opposite the razor blade.

3. The liquid-dispensing razor according to claim 1, wherein the razor head is removably disposed upon the outflow end of the handle.

4. The liquid-dispensing razor according to claim 1, further comprising:
a flexible water supply line connected to the inflow ends of said handle, the water supply line being adapted for connection to a water supply; and
a foot-actuated water control valve disposed in the water supply line, the valve having an open position permitting water to flow from the water supply into said handle and a closed position shutting off the flow of water.

5. The liquid-dispensing razor according to claim 4, wherein a portion of the flexible water supply line is coiled.

6. The liquid-dispensing razor according to claim 4, further comprising a portable water container connected to said water supply line.

7. The liquid-dispensing razor according to claim 6, further comprising a pressure pump control connected to the portable water container.

8. A liquid-dispensing razor, comprising:
an elongate hollow handle defining a water passage therethrough, the handle having an inflow end and an outflow end opposite the inflow end;
a razor head disposed upon the outflow end of the handle, the head having a water channel defined therein, the water channel communicating with the water passage of the handle, the head further having a plurality of water outlet pores defined therein, the water outlet pores communicating with the water channel in the razor head;
at least one razor blade installed within the razor head, the at least one razor blade having a cutting edge extending slightly from the razor head, the pores in the razor head being distributed immediately adjacent and in front of the cutting edge of the razor blade; and
a water flow control valve disposed at the outflow end of the handle adjacent the razor head and opposite the razor blade.

9. The liquid-dispensing razor according to claim 8, wherein the water outlet pores are distributed in a linear array.

10. The liquid-dispensing razor according to claim 8, wherein the razor head is removably disposed upon the outflow end of the handle.

11. The liquid-dispensing razor according to claim 8, further comprising:
a flexible water supply line connected to the inflow ends of said handle, the water supply line being adapted for connection to a water supply; and
a foot-actuated water control valve disposed in the water supply line, the valve having an open position permitting water to flow from the water supply into said handle and a closed position shutting off the flow of water.

12. The liquid-dispensing razor according to claim 11, wherein a portion of the flexible water supply line is coiled.

13. The liquid-dispensing razor according to claim 11, further comprising a portable water container connected to said water supply line.

14. The liquid-dispensing razor according to claim 13, further comprising a pressure pump control connected to the portable water container.

15. A liquid-dispensing razor, comprising:
an elongate hollow handle defining at least one shaving fluid container therein, the handle having an open razor head attachment end;
a razor head disposed upon the razor head attachment end of the handle, the head having a fluid channel defined therein, the fluid channel communicating with the shaving fluid container of the handle, the head further having a plurality of liquid outlet pores defined therein, the liquid outlet pores communicating with the fluid channel in the razor head; and
at least one liquid pump disposed within the handle and communicating with the shaving fluid container of the handle.

16. The liquid-dispensing razor according to claim 15, wherein the razor is a safety razor.

17. The liquid-dispensing razor according to claim 15, wherein the razor is a straight razor.

18. The liquid-dispensing razor according to claim 15, wherein:
said at least one shaving fluid container comprises two mutually separate shaving fluid containers; and
said at least one liquid pump comprises two mutually separate pneumatic pumps, each of the pumps communicating with a corresponding one of the shaving fluid containers.

19. The liquid-dispensing razor according to claim 15, wherein said at least one liquid pump comprises a hand-actuated pressure pump therewith.

20. The liquid-dispensing razor according to claim 15, wherein said at least one liquid pump comprises a mechanical pump.
